(19) United States
(12) Patent Application Publication
(10) Pub. No.: US 2009/0003701 A1
(43) Pub. Date: Jan. 1, 2009

(54) METHOD AND APPARATUS FOR APPLYING STEGANOGRAPHY TO DIGITAL IMAGE FILES

(75) Inventor: Mandeep Singh Rekhi, Bangalore (IN)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES, INC., Murray Hill, NJ (US)

(21) Appl. No.: 11/772,124

(22) Filed: Jun. 30, 2007

(51) Int. Cl. G06K 9/34

(52) U.S. Cl. 382/176

(57) ABSTRACT

A method and apparatus for applying steganography to digital image files are provided. This algorithm uses the basic idea of steganography. In one aspect of the invention a method is provided. The method comprises (a) taking a text message as input, (b) breaking up the input data into a series of bits, and (c) passing it to an encryption mechanism to merge into a bit map image. Thus, less important information from a bit map image is removed and hidden data (series of bits) is injected in its place. It is thus possible to (a) retrieve the entire bit map file, (b) remove its header information, (c) retrieve each byte one by one and (d) put the input data in each byte.

### BACKGROUND OF THE INVENTION

This invention relates to a method and apparatus for applying steganography to digital image files. While the invention is particularly directed to the art of telecommunications, and will be thus described with specific reference thereto, it will be appreciated that the invention may have usefulness in other fields and applications.

In an ideal world we would all be able to openly send encrypted email or digital files to each other with no fear of reprisals. However, there are often cases when this is not possible, either because one is working for a company that does not allow encrypted email or perhaps the local government does not approve of encrypted communication (a reality in some parts of the world). This is where cryptology and steganography can come into play.

Over the centuries, many different methods have been developed to send messages or other information in a form that cannot be understood by anyone other than the intended recipient. Such methods have typically involved encrypting the information by replacing the letters or numbers, words, or phrases of the message with other letters and/or numbers. Decryption of the information is achieved through use of a key which may include instructions and other information, special materials, and a device, and which enables the recipient to recover the original message or information from the encrypted communication.

Steganography, the art of hiding messages inside other messages, has until recently been the poor cousin of cryptography. Now it is gaining new popularity with the current industry demands for digital watermarking and fingerprinting of audio and video. The biggest advantage steganography provides over cryptography is that there is no hint for the intruder (passive or active) that the file might contain some hidden data. Cryptography loudly announces that the data being sent is an important one and needs to be saved from unauthorized access.

In a nutshell, the goal of steganography is to hide messages inside other harmless messages in a way that does not allow any enemy to detect that there is a second secret message. The message can be in any form—audio, video or data.

An early method of steganography involved Trithemius' scheme of concealing messages in long invocations of the names of angels, with the secret message appearing as a pattern of letters within the words. For example, the message may appear as every other letter in every other word in the phrase: “padiel aporsy mesarpon omeuas peludyn malpreaxo,” which reveals “prymus apex.”

Another early method of steganography was the “Ave Maria” cipher. The book contains a series of tables, each of which has a list of words, one per letter. To code a message, the message letters are replaced by the corresponding words. If the tables are used in order, one table per letter, then the coded message will appear to be an innocent prayer.

Thus, steganography simply takes one piece of information and hides it within another. Computer files (images, sounds recordings, even disks) contain unused or insignificant areas of data. Steganography takes advantage of these areas, replacing them with information (encrypted mail, for instance). The files can then be exchanged without anyone knowing what really lies inside of them. An image of the space shuttle landing might contain a private letter to a friend. A recording of a short sentence might contain your company's plans for a secret new product. Steganography can also be used to place a hidden “trademark” in images, music, and software, a technique referred to as watermarking.

For example, U.S. Pat. No. 6,537,747 to Mills, Jr. et al. is directed to methods for (a) encrypting information in the form of words, numbers, or graphical images, by obtaining a set of nucleic acid strands or nucleic acid analog strands having subunit sequences selected to represent the information, (b) transmitting the information by sending the nucleic acids or nucleic acid analogs to a recipient who possesses a key for decryption, and (c) using the key to decrypt the information and recover the words, numbers, or represented by the nucleic acids or nucleic acid analogs.

The present invention contemplates a new and improved that resolves the above-referenced difficulties and others.

### SUMMARY OF THE INVENTION

A method and apparatus for applying steganography to digital image files are provided. This algorithm uses the basic idea of steganography.

In one aspect of the invention a method is provided. The method comprises (a) taking a text message as input, (b) breaking up the input data into a series of bits, and (c) passing it to an encryption mechanism to merge into a bit map image. Thus, less important information from a bit map image is removed and hidden data (series of bits) is injected in its place.

It is thus possible to (a) retrieve the entire bit map file, (b) remove its header information, (c) retrieve each byte one by one and (d) put the input data in each byte.

In another aspect of the invention an apparatus is provided. The apparatus comprises (a) an image reader, (b) a text reader, (c) an object-to-character converter, (d) an character-to-bit converter; (e) a steganography encrypter, (f) a character-to-object converter, and (g) an image writer.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a telecommunication network 10 suitable for implementing aspects of the present invention;

FIG. 2 shows a sequence of 24 bits represents a single pixel in a digital image;

FIG. 3 shows an example of the least significant (rightmost) bit of each 8-bit byte being used to hide a text message;

FIG. 4 shows 11 pixels, which represent part of a solid-color background;

FIG. 5 illustrates an exemplary method of embedding a message in a digital image;

FIG. 6 illustrates an exemplary method of decrypting a message hidden in a digital image;

FIG. 7 shows a system suitable for implementing aspects of the exemplary embedding method; and

FIG. 8 shows a system suitable for implementing aspects of the exemplary extraction method.

### DETAILED DESCRIPTION

Some portions of the description below are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to systems for performing the operations herein. These systems may be specially constructed for the required purposes, or they may comprise one or more general-purpose computers selectively activated or reconfigured by one or more computer programs stored in the computer(s). Such computer program(s) may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems will be apparent from the description. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); and the like.

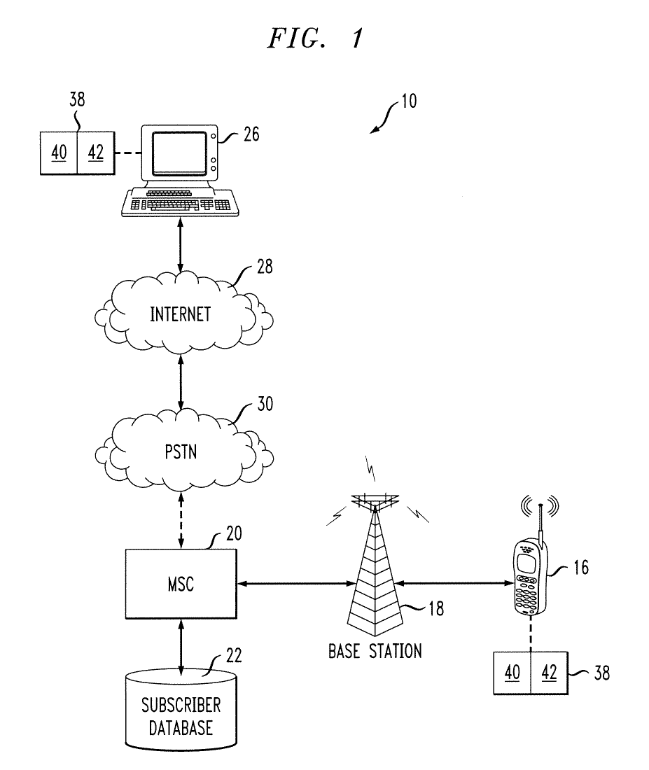

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 is a block diagram of a telecommunication network 10 suitable for implementing aspects of the present invention.

Included in FIG. 1 is a first communication device 16. The first communication device 16 is shown as a wireless device (or a mobile station), which includes a user interface. The first communication device 16 typically includes a user interface and an interface for coupling to the radio access network (RAN). The user interface of the first communication device 16 is typically referred to as terminal equipment and generally includes an audio interface, such as a microphone and speakers, a visual interface, such as a display, and a user input interface, such as a keyboard or touch pad. The interface for coupling to the RAN is typically referred to as a mobile terminal and generally includes an over-the-air interface for transmitting and receiving data. The over-the-air interface of the first communication device 16 is used to communicate with any number of base stations 18 in the RAN. The communication device 16 and the base stations 18 in the RAN may communicate over-the-air using various transmission methods, including packet-based protocols.

The base station 18 is generally a central radio transmitter/receiver, which maintains communications with the wireless communication devices 16 within a given range (typically a cell site). The base station 18 is coupled to a mobile switching center (MSC) 20, which is generally a switch that provides services and coordination between mobile users in a network and external networks.

The MSC 20 is a processor-based apparatus with data link interfaces for coupling together as described above and shown in FIG. 1. The MSC 20 includes one or more processors that execute programs to implement the functionality described herein and generally associated with wireless systems. The flexibility of this processor-based system permits ready integration into this system of a private conference calling chat room method and system in accordance with the present invention. Such a processor-based system commonly includes a high speed processing unit (CPU) in conjunction with a memory system (with volatile and/or nonvolatile memory), an input device, and an output device, all as well known to those skilled in the art.

The MSC 20 is essentially a switching element that routes calls and performs call handling functions. Although only one MSC 20 is shown in the figure, it is to be understood that the telecommunications system 10 may include any number of MSCs that are spaced geographically apart. The MSC 20 routes calls by accessing information in a subscriber database 22, such as a home location register (HLR). It should also be understood that switching elements of different types may be used in networks that vary from the example network 10.

The subscriber database 22 typically contains subscriber/customer profile information, and it may also contain mobility management information, in the case of wireless networks. The subscriber database 22 may maintain at least two types of subscriber information: subscription information and location information. Subscription information refers to the services that each subscriber is authorized to use under the subscriber's calling plan, including conference calling services. The subscriber database 22 uses the subscription information to verify that the subscriber is authorized for certain types of services. One type of location information is the last MSC that was registered as serving the subscriber. This is stored in the form of a mobile switching center identification number, which identifies the appropriate MSC. Other location information is used to calculate tax on the cost of a call, for example. In addition, the subscriber is identified using a mobile identification number Location information is used to properly route and bill the call.

FIG. 1 also shows a second communication device 26 operatively connected via the Internet 28 as known in the art. The second communication device 26 optionally employs a wireless local area network (WLAN) or wire line, in the usual manner, to operatively connect to the Internet 28.

An IP-based network 28 such as the Internet (or an IP Multimedia System (IMS)) is composed of nodes of computers, servers, routers, and communications links, etc. It employs packet-switching technology that decomposes data (e.g., voice, Web sites, e-mail messages) into IP packets. Each packet is then transmitted over an IP network to a destination identified by an IP address and reassembled at the destination. An IP transmission is completed without pre-allocating resources from point to point.

The communication devices may be operatively connected to the Public Switched Telephony Network (PSTN) 30. The PSTN 30 refers to the public telephone networks as we know them and is composed of switches and T1/E1 trunks, central offices, etc., all as known to those skilled in the art. The PSTN 14 uses circuit-switched technology in which necessary resources are allocated (dedicated) for the duration of a phone call.

Only two communication devices (16 and 26) are shown in FIG. 1 for the purpose of simplifying the diagram. However, it is to be appreciated that any number of such communication devices may be situated in the telecommunications system 10. Additionally, while each is depicted as a specific type of communication device, other like devices may also be incorporated.

Further, a steganography device 38 may be operatively connected to each of the communication devices 16 and 26. The steganography device 38 generally includes a message embedding module 40 and a message decryption module 42. The steganography device 38 may be built into the communication device or a separate unit. A function of the message embedding module 40 and the message decryption module 42 is to facilitate the transmission of secret messages between users of the communication devices shown in FIG. 1. The message embedding module 40 and the message decryption module 42 generally comprise a CPU (not shown) such as a microprocessor or a secure server. The functions performed by the message embedding module 40 and the message decryption module 42 are described in greater detail below.

Digitized images and video may harbor plenty of white noise. A digitized photograph is stored as an array of colored dots, called pixels. Each pixel typically has three numbers associated with it, one each for red, green, and blue intensities, and these values often range from 0-255. Each number is stored as eight bits (zeros and ones), with a one worth 128 in the most significant bit (on the left), then 64, 32, 16, 8, 4, 2, and a one in the least significant bit (on the right) worth just 1.

A difference of one or two in the intensities is imperceptible, and, in fact, a digitized picture can still look good if the least significant four bits of intensity are altered—a change of up to 16 in the color's value. This gives plenty of space to hide a secret message. Text is usually stored with 8 bits per letter, so we could hide 1.5 letters in each pixel of the cover photo. A 640×480 pixel image, the size of a small computer monitor, can hold over 400,000 characters. That is the equivalent of a whole novel hidden in one modest photo.

One aspect of good steganography is making the message look random before hiding it. One solution is simply to encode the message before hiding it. Using a good code, the coded message will appear just as random as the picture data it is replacing. Another approach is to spread the hidden information randomly over the photo. “Pseudo-random number” generators take a starting value, called a seed, and produce a string of numbers which appear random. For example, pick a number between 0 and 16 for a seed. Multiply your seed by 3, add 1, and take the remainder after division by 17, repeating this process several times. Unless you picked 8, you'll find yourself somewhere in the sequence 1, 4, 13, 6, 2, 7, 5, 16, 15, 12, 3, 10, 14, 9, 11, 0, 1, 4, . . . which appears somewhat random. To spread a hidden message randomly over a cover picture, use the pseudo-random sequence of numbers as the pixel order. Descrambling the photo requires knowing the seed that started the pseudo-random number generator.

Steganography strips less important information from digital content and injects hidden data in its place. This is done over the spectrum of the entire image. Here is one way it may be implemented.

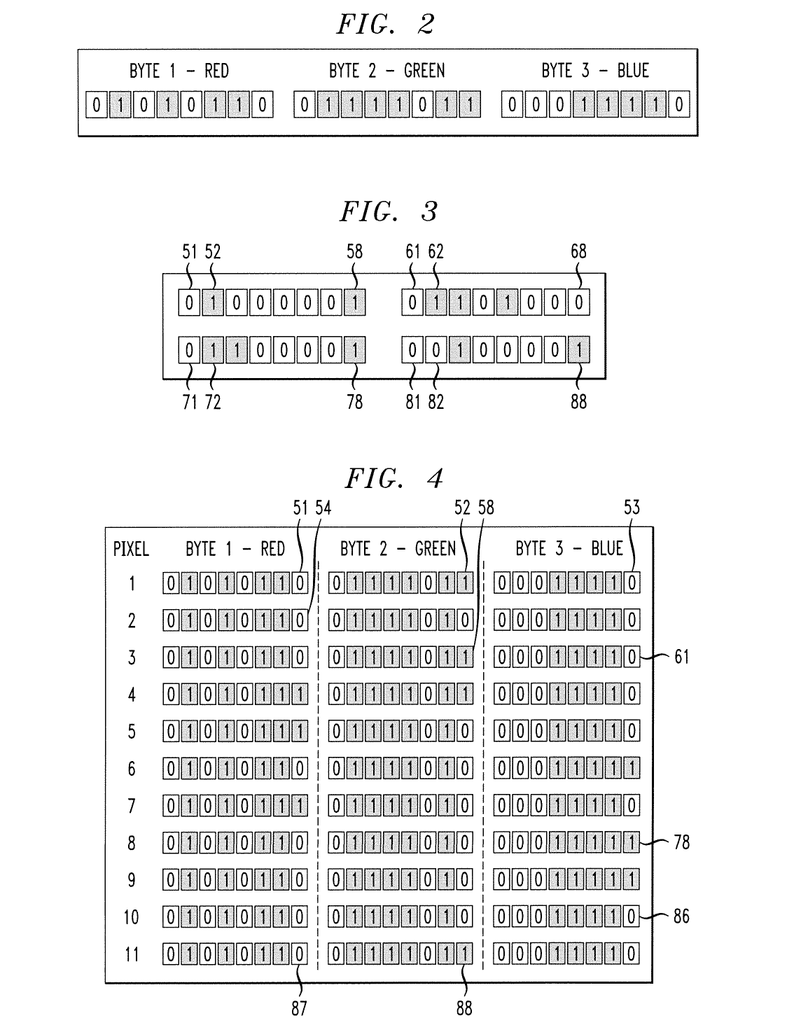

With reference now to FIG. 2, a sequence of 24 bits represents a single pixel in a digital image. Its 3 bytes of color information provide a total of 256 different values for each color (i.e., red, green and blue) and thus can represent a total of 16.7 million colors. This particular value would display as dark green. Let us take 11 of these pixels that represent, say, part of a solid-color background.

In FIG. 3, the least significant (rightmost) bit of each 8-bit byte has been co-opted to hide a text message—the four characters “Aha!”—in ASCII binary. These bits have been mapped in FIG. 3 with reference numerals.

The bits behind those 11 pixels are shown in FIG. 4. The reference numerals from FIG. 3 are shown along with some additional reference numerals representing additional bits. The hidden message occupies 32 of those 264 bits (about 12%) and contains four 8-bit bytes. In the diagram, the first series of boxes represents bits that had to be changed to include the hidden message. Notice that only 15 of 264 bits (less than 6%) had to be changed and only eight of the 11 pixels were altered. If instead of 11 pixels we had a 300 KB bitmap file, we could accommodate a text message of 36 KB, or about 6,000 words.

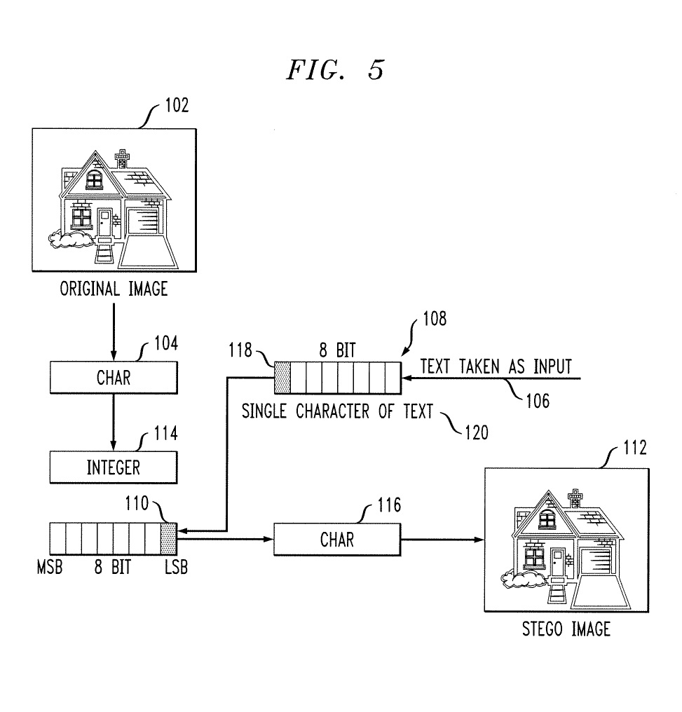

Thus, the method of embedding a message in a digital image is illustrated in FIG. 5. Initially, an original digital image 102 is read, and objects in the digital image 102 are converted to characters 104. Meanwhile, suffix a new character indicating the length of message in actual text message, and that text string 106 containing the desired message is read, and the text string is then converted to a string of bits 108. The character 104 is an ASCII character which contains 8 bits. To modify the least significant (rightmost) bit into that, it will need to be converted to an integer 114 so the least significant bit can be modified using a bit wise operator.

The least significant bit (LSB) 110 is thus replaced with a first bit 118 of a single character of text 120. This process is repeated eight times to complete a single character of text 120. This process is repeated until all of the characters in the text string have been embedded in the image 102. The output is an image 112 containing the text character 116, which is negligibly distracted from the character 106.

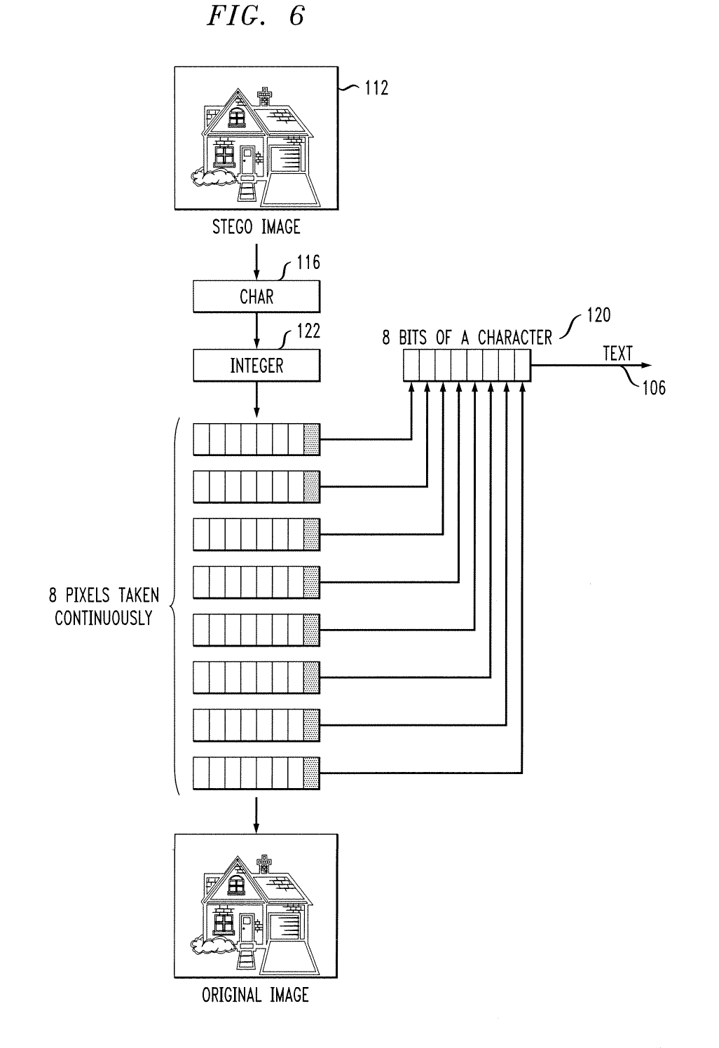

The method of extracting the message 106 hidden in the digital image 112 is illustrated in FIG. 6. Initially, a digital image 112 is read, and objects in the digital image 112 are converted to characters 116. Character 116 is an ASCII character which contains 8 bits. To extract the least significant (rightmost) bit from that, it will need to be converted to integer 122, so the least significant bit can be extracted using a bit wise operator. This process is continued for 8 times, and all 8 bits will be put together in the same sequence from the most significant bit to the least significant bit (from left to right) to construct an 8 bit single character 120. The first character revealed from the image indicates the count of characters embedded in the digital image 112. This process will be repeated until all characters, revealed as the first character, are extracted from the digital image 112. After, put all the characters in a string to complete the actual text message 106.

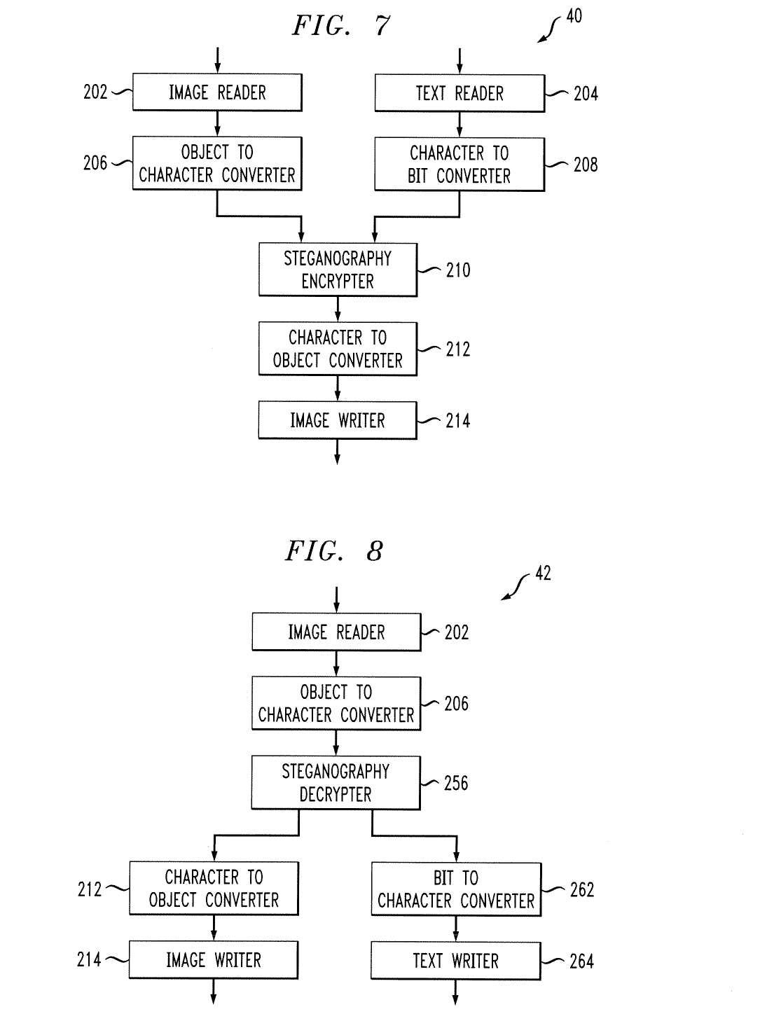

The embedding module 40, which is suitable for implementing the exemplary embedding method, is shown in FIG. 7. The module 40 generally includes an image reader 202, a text reader 204, an object-to-character converter 206, an character-to-bit converter 208, a steganography encrypter 210, a character-to-object converter 212, and an image writer 214. The image reader 202 is a digital file reader, which reads the header of the image and continues to read pixels from the image and pass them to the object-to-character converter 206. The image reader 202 is specific to the digital image and is used to embed the message. The text reader 204 reads text either from the user or any text file, which contains the actual message 106 to embed. The object-to-character converter 206 reads an object passed by the image reader 202. The object is a set of three characters in the current context, and the object-to-character converter 206 will break 3 characters in an object into three separate characters. The character-to-bit converter 208 breaks each character and passes 8 separate bits one-by-one to the steganography encrypter 210. The steganography encrypter 210 will encrypt each bit received from the character-to-bit converter 208 into each character received from the object-to-character converter 206. The character-to-object converter 212 will convert the embedded characters back to objects. It will pick up 3 characters, and it will build a single pixel object, which it will pass to the image writer 214. The image writer 214 writes pixel objects into digital images and also writes the header to a specific digital format.

The decryption module 42, which is suitable for implementing the exemplary extraction method, is shown in FIG. 8. The system 42 generally includes an image reader 202, an object-to-character converter 206, a steganography decrypter 256, a character-to-object converter 212, an image writer 214, a bit-to-character converter 262, and a text writer 264. The steganography decrypter 256 will extract the least significant bit from the character received from the object-to-character converter 206. After extracting 8 bits, it will construct a character. It will pass the character to the character-to-object converter 212. The bit-to-character converter 262 will build up a character from 8 bits received from the stegnography extracter 256. The text writer 264 will write each character received from the bit-to-character converter 262 into a file to build up the complete embedded message.

Thus, an “8-bit” digital image, one capable of conveying 256 colors, uses 8 bits to represent one pixel, or picture element. It is not remarkable today to see images that encode thousands or millions of colors, where 32 bits are used to represent each pixel. If least significant bit, 32nd bit, is changed, then there will be very minor impact in image. Putting a message in that 32nd bit would not significantly (or even perceptibly) alter the digital image. An 8-bit digital image that measured 480 by 100 pixels, the size of many web page banners, theoretically can hold 5000 letters of text. And that is a small image. A big 32-bit image could hold much, much more. The message to be steganographically applied to a digital image does not have to be in plain text, it can be a PGP-encrypted missive. So you can have your encryption cake and send the results without others being aware of it.

There has been a rapid growth of interest in this subject over the last two years, and for two main reasons. Firstly, the publishing and broadcasting industries have become interested in techniques for hiding encrypted copyright marks and serial numbers in digital _Ims, audio recordings, books and multimedia products; an appreciation of new market opportunities created by digital distribution is coupled with a fear that digital works could be too easy to copy. Secondly, moves by various governments to restrict the availability of encryption services have motivated people to study methods by which private messages can be embedded in seemingly innocuous cover messages. The ease with which this can be done may be an argument against imposing restrictions. Other applications for steganography include the automatic monitoring of radio advertisements, where it would be convenient to have an automated system to verify that adverts are played as contracted; indexing of video mail, where we may want to embed comments in the content; and medical safety, where current image formats such as DICOM separate image data from the text (such as the patient's name, date and physician), with the result that the link between image and patient occasionally gets mangled by protocol converters. Thus embedding the patient's name in the image could be a useful safety measure.

Where the application involves the protection of intellectual property, we may distinguish between watermarking and fingerprinting. In the former, all the instances of an object are marked in the same way, and the object of the exercise is either to signal that an object should not be copied, or to prove ownership in a later dispute. One may think of a watermark as one or more copyright marks that are hidden in the content. With fingerprinting, on the other hand, separate marks are embedded in the copies of the object that are supplied to different customers. The elect is somewhat like a hidden serial number: it enables the intellectual property owner to identify customers who break their license agreement by supplying the property to third parties. In one system we developed, a specially designed cipher enables an intellectual property owner to encrypt a _Im soundtrack or audio recording for broadcast, and issue each of his subscribers with a slightly different key; these slight variations cause imperceptible errors in the audio decrypted using that key, and the errors identify the customer. The system also has the property that more than four customers have to collude in order to completely remove all the evidence identifying them from either the keys in their possession or the audio that they decrypt. Using such a system, a subscriber to a music channel who posted audio tracks to the Internet, or who published his personal decryption key there, could be rapidly identified. The content owner could then either prosecutes him; revoke his key, or both.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method comprising:
taking a text message as input data;
breaking up the input data into a series of bits; and
passing the series of bits to an encryption apparatus to merge into a bit map image.

2. The method of claim 1 further comprising:
retrieving the entire bit map image;
removing header information from the bit map image;
retrieving each byte; and
putting the input data in each byte.

3. An apparatus comprising:
an image reader;
a text reader;
an object-to-character converter;
an character-to-bit converter;
a steganography encrypter;
a character-to-object converter; and
an image writer.
